(19) United States
(12) Patent Application Publication
(10) Pub. No.: US 2006/0221308 A1
(43) Pub. Date: Oct. 5, 2006

(54) Display system controlled based on user behavior and controlling method thereof

(75) Inventor: Chang-Hung Lee, Taoyuan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/396,200

(22) Filed: Mar. 30, 2006

(30) Foreign Application Priority Data
Mar. 30, 2005 (TW) 094110126

(51) Int. Cl. G03B 21/20

(52) U.S. Cl. 353/85

(57) ABSTRACT

A display system controlled based on users' behavior is provided. The display system is used for displaying an image. The display system includes a timer, an analyzing module, and a projecting apparatus. The timer is used for counting a current time. The analyzing module generates at least one standby time period based on a set of predetermined information, wherein the set of predetermined information relates to users' behavior. The projecting apparatus for projecting the image is selectively in a projecting mode, a standby mode and a turning-off mode. When the current time is in the at least one standby time period, the projecting apparatus is selectively in the projecting mode and the standby mode.

### BACKGROUND OF THE INVENTION

1. Field of the Invention

This invention relates to a display system. More specifically, this invention is related to a projection display system controlled based on user behavior.

2. Description of the Prior Art

With the advantages of small size, easy to be assembled, and capable of providing large images, projection display apparatuses have been broadly used in public places, enterprises, and even families. Presently, methods for projection display can be mainly categorized into two kinds: front projection and rear projection. Both the two methods need projectors for projecting images to be displayed. Generally speaking, lamps are the most expensive device in projectors; however, lamps are also the devices that are damaged most easily. After being turned on, projectors cannot display images immediately like conventional CRT TVs. To prevent lamps form being affected by transient voltages, there is usually a warm-up time for projectors. During the warm-up time, a voltage is gradually provided the lamp. Only after the warm-up operation is completed, the projection apparatus can achieve normal operation. That is to say, users must wait for a while before starting to watch images or programs. Inevitably, if the warm-up time is too long, users might miss the most important parts of programs.

The U.S. Pat. No. 5,444,499 discloses an audio/video apparatus, which can record a user's favors about channels and volume. Based on the records, the apparatus would show suggestions to remind the user not to miss his favorite programs.

To solve the aforementioned warm-up problems, this invention provides a display system controlled based on user behavior the controlling method for the display system. The display system according to this invention records the time when users usually turn on/off the display system in a database. Based on the records, the display system is automatically warmed-up before the time that the users used to turn on the display system.

### SUMMARY OF THE INVENTION

The main purpose of this invention is providing a display system controlled based on user behavior. The display system is used for displaying an image.

The first preferred embodiment according to this invention is a display system including a timer, an analyzing module, and a projecting apparatus. The timer is used for counting a current time. The analyzing module generates a standby time period based on a set of predetermined information that is related to user behavior. The projecting apparatus is used for projecting the image and is selectively in a projecting mode, a standby mode and a turning-off mode. When the current time is in the standby time period, the projecting apparatus is selectively in the projecting mode and the standby mode.

Besides the aforementioned timer, analyzing module, and projecting apparatus, the display system of the second preferred embodiment according to this invention further includes a user control unit and a switching module. The user control unit is actuated by a user for producing commands representing the requests of the user to selectively set the projecting apparatus into the projecting mode, the standby mode and the turning-off mode. The set of predetermined information is also relative to the commands. The switching module is used for switching the projecting apparatus between the projecting mode and the standby mode, and switching the projecting apparatus between the projecting mode and the turning-off mode.

The advantage and spirit of the invention may be understood by the following recitations together with the appended drawings.

### BRIEF DESCRIPTION OF THE APPENDED DRAWINGS

FIG. 1 shows the block diagram of the display system according to this invention.

### DETAILED DESCRIPTION OF THE INVENTION

The main purpose of this invention is providing a display system, such as a projection TV or a projection monitor, controlled based on user behavior.

The first preferred embodiment according to this invention is a display system including a timer, an analyzing module, and a projecting apparatus. The timer is used for counting a current time. The analyzing module generates at least one standby time period based on a set of predetermined information that is related to user behavior. The projecting apparatus is used for projecting the image and is selectively in a projecting mode, a standby mode and a turning-off mode. When the current time is in any of the standby time periods, the projecting apparatus is selectively in the projecting mode and the standby mode. When the current time is out of all standby time periods, the projecting apparatus is selectively in the projecting mode and the turning-off mode.

Actually, most people have regular life habits. Some people are used to watching soap operas during eight and nine o'clock every night; some people are used to watching programs about stock quotes every morning. In this invention, the set of predetermined information is related to users' behavior. For example, the set of predetermined information might includes that a user usually uses the display system during eight and ten o'clock every night. According to this information, the analyzing module may set five to eight through ten o'clock every night as a standby time period. When the current time counted by the counter is up to five to eight and if the projecting apparatus is not in the projecting mode, the projecting apparatus is automatically set into the standby mode and a warm-up operation is started. Thus, when the user wants to use the display system at eight o'clock, he can watch programs immediately and doesn't have to wait for the completion of warm-up operation. Accordingly, when the current time counted by the counter is in the at least one standby time period, the projecting apparatus is selectively in the projecting mode and the standby mode. Beside users' behavior, the set of predetermined information can also be related to terms assigned by the user himself.

When in the standby mode, the projecting apparatus shows a blank image or nothing. The projecting apparatus includes a light source, such as a lamp. Typically, changing the voltage provided to the light source can adjust the brightness of the light source. In the display system according to this invention, when the projecting apparatus is in the projecting mode, the light source is supplied with a first power level; when the projecting apparatus is in the standby mode, the light source is supplied with a second power level. The purpose of providing a voltage to the light source during a standby mode is maintaining the projecting apparatus in a warmed-up state with basic power. By contrast, the demand on brightness is higher in the projecting mode. Thus, the first power level is higher than the second power level. Since the light source of the projecting apparatus is set at a lower power level instead of being turned off in the standby mode, the time needed for switching the projecting apparatus from the standby mode to the projecting mode is shorter than the time needed for switching the projecting apparatus from the turning-off mode to the projecting mode. Accordingly, the display system can not only save power, but can also shorten the time that a user waits.

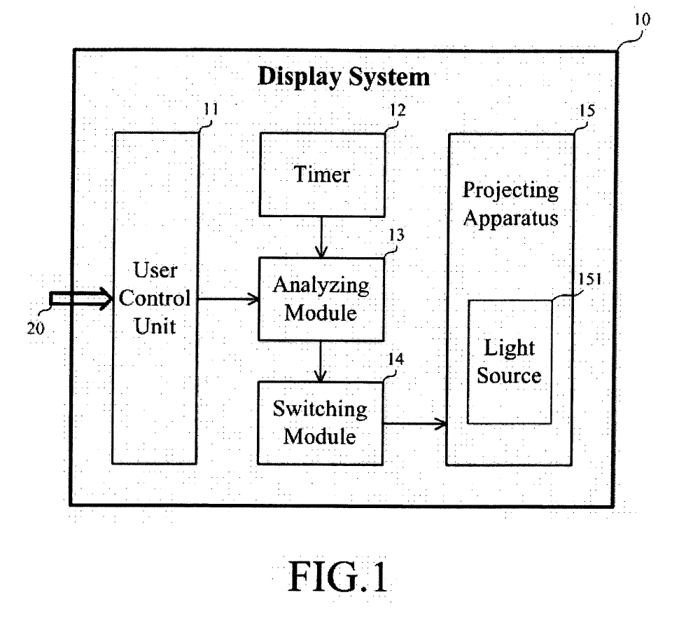

Please refer to FIG. 1. FIG. 1 shows the block diagram of the display system of the second preferred embodiment according to this invention. The display system 10 includes a user control unit 11, a timer 12, an analyzing module 13, a switching module 14, and a projecting apparatus 15. The projecting apparatus 15 further includes a light source 151.

Via the user control unit 11, a user can generate a command 20 representing the request of the user to selectively set the projecting apparatus into the projecting mode, the standby mode and the turning-off mode. The timer 12 is used for counting a current time. The analyzing module 13 generates at least one standby time period based on a set of predetermined information that is related to the command 20. The projecting apparatus 15 is used for projecting an image and is selectively in a projecting mode, a standby mode and a turning-off mode. The switching module 14 is used for switching the projecting apparatus 15 between the projecting mode and the standby mode, and switching the projecting apparatus 15 between the projecting mode and the turning-off mode. When the current time is in the at least one standby time period, the projecting apparatus 15 is selectively in the projecting mode and the standby mode. When the current time is out of the at least one standby time period, the projecting apparatus 15 is selectively in the projecting mode and the turning-off mode.

According to this invention, the method for controlling a projection apparatus first generates at least one standby time period based on a set of predetermined information and counts a current time. The projecting apparatus is used for projecting an image and is selectively in a projecting mode, a standby mode and a turning-off mode. When the current time is in the at least one standby time period, the projecting apparatus is selectively set into the projecting mode and the standby mode. When the current time is out of the at least one standby time period, the projecting apparatus is selectively set into the projecting mode and the turning-off mode.

When the projecting apparatus 15 is in the projecting mode, the light source 151 is supplied with a first power level; when the projecting apparatus 15 is in the standby mode, the light source 151 is supplied with a second power level. The second power level is lower than the first power level.

The display system and controlling method thereof can be applied in all kinds of projection display systems to solve the problem of long warm-up times.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A display system for displaying an image, the display system comprising:
a timer for counting a current time;
an analyzing module for generating a standby time period based on a set of information; and
a projecting apparatus for projecting the image, the projecting apparatus being selectively in a projecting mode, a standby mode and a turning-off mode;
wherein when the current time is in the standby time period, the projecting apparatus is selectively in the projecting mode and the standby mode.

2. The display system of claim 1, further comprising:
a switching module for switching the projecting apparatus between the projecting mode and the standby mode, and switching the projecting apparatus between the projecting mode and the turning-off mode.

3. The display system of claim 2, wherein a first time period needed for switching the projecting apparatus from the turning-off mode to the projecting mode is longer than a second time period needed for switching the projecting apparatus from the standby mode to the projecting mode.

4. The display system of claim 1, wherein when the current time is out of the standby time period, the projecting apparatus is selectively in the projecting mode and the turning-off mode.

5. The display system of claim 1, wherein the projecting apparatus comprises a light source, when the projecting apparatus is in the projecting mode, the light source is supplied with a first power level, when the projecting apparatus is in the standby mode, the light source is supplied with a second power level, and the second power level is lower than the first power level.

6. The display system of claim 1, wherein the projecting apparatus shows a blank image when the projecting apparatus is in the standby mode.

7. The display system of claim 1, wherein the display system is a projection TV or a projection monitor.

8. The display system of claim 1, further comprising:
a user control unit actuated by a user for producing commands representing the requests of the user to selectively set the projecting apparatus into the projecting mode, the standby mode and the turning-off mode, wherein the set of information is relative to the commands.

9. A method of controlling a projecting apparatus for projecting an image, the projecting apparatus being selectively in a projecting mode, a standby mode and a turning-off mode, said method comprising:
generating a standby time period based on a set of information; and
counting a current time;
wherein when the current time is in the standby time period, the projecting apparatus is selectively in the projecting mode and the standby mode.

10. The method of claim 9, wherein when the current time is out of the standby time period, the projecting apparatus is selectively in the projecting mode and the turning-off mode.

11. The method of claim 9, wherein the projecting apparatus comprises a light source, when the projecting apparatus is in the projecting mode, the light source is supplied with a first power level, when the projecting apparatus is in the standby mode, the light source is supplied with a second power level, and the second power level is lower than the first power level.

12. The method of claim 9, wherein the projecting apparatus shows a blank image when the projecting apparatus is in the standby mode.

13. The method of claim 9, wherein the set of information is relative to commands transmitted by a user, and the commands represent the requests of the user to set the projecting apparatus into the projecting mode, the standby mode or the turning-off mode.

14. The method of claim 9, wherein the projecting apparatus is a projection TV or a projection monitor.
